(19) United States
(12) Patent Application Publication
(10) Pub. No.: US 2026/0278882 A1
(43) Pub. Date: Sep. 17, 2026

(54) IMAGE GENERATION METHOD AND APPARATUS AND NEURAL NETWORK TRAINING METHOD AND APPARATUS

(71) Applicant: Ying ZHAO, Beijing (CN)

(72) Inventor: Ying ZHAO, Beijing (CN)

(73) Assignee: Ricoh Company, Ltd., Tokyo (JP)

(21) Appl. No.: 19/560,653

(22) Filed: Mar. 9, 2026

(30) Foreign Application Priority Data
Mar. 11, 2025 (CN) 202510280044.2

(51) Int. Cl. G06T 11/60; G06T 3/20; G06T 3/40; G06T 3/60; G06T 7/13; G06T 7/50; G06T 11/10

(52) U.S. Cl. CPC G06T 11/60; G06T 3/20; G06T 3/40; G06T 3/60; G06T 7/13; G06T 7/50; G06T 11/10; G06T 2207/10024; G06T 2207/10028; G06T 2207/20081; G06T 2207/20084; G06T 2210/22

(57) ABSTRACT

A method of generating an image is provided. The method includes a step of obtaining a first target image for image generation; a step of obtaining a reference depth image indicating a reference depth feature of the first target image as well as a reference edge image indicating a reference edge feature of the first target image; and a step of generating, based on the reference depth image and the reference edge image, a first depth image and a first edge image corresponding to the first target image by utilizing a first generative neural network.

### CROSS-REFERENCE TO RELATED APPLICATIONS

The present disclosure is based on and claims the benefit of priority of Chinese Patent Application No. 202510280044.2 filed on Mar. 11, 2025, the entire contents of which are hereby incorporated by reference.

### BACKGROUND OF THE INVENTION

### 1. Field of the Invention

The present disclosure relates to the field of image processing, and specifically, a method and apparatus for generating an image as well as a method and apparatus for training a neural network.

### 2. Description of the Related Art

The technology of generating expected images by utilizing collected images and training a neural network for defect detection on the basis of the expected images to conduct product defect detection is one of the most important research topics. Generally speaking, defect detection is an important factor in controlling product quality. Because various types of defects may continuously occur in production, it is typically impossible to exhaustively enumerate the circumstances of the various types of defects (e.g., texture and shapes). As such, how to robustly and automatically detect these kinds of defects is a problem that urgently needs to be solved.

In the current defect detection methods, it is usually possible to train a neural network for defect detection by way of a large number of simulated defect samples. However, in the process of training and detection, the generated images are insufficient to simulate the real defects of products, especially those with depth variations such as bumps, pits, and the like, so it is difficult to accurately detect and locate the defects in the generated images. As a result, it is impossible to meet the practical needs of achieving universal detection.

Therefore, there is a need for an improved image generation method and apparatus as well as neural network training method and apparatus to achieve defect target generation and defect detection under different depth features in different application scenarios, so as to satisfy different image generation requirements and perform accurate defect detection.

### SUMMARY OF THE INVENTION

In order to solve the above technical problems, according to a first aspect of the present disclosure, a method of generating an image is provided that includes steps of
obtaining a first target image for image generation;
obtaining a reference depth image indicating a reference depth feature of the first target image and a reference edge image indicating a reference edge feature of the first target image; and
generating, based on the reference depth image and reference edge image, a first depth image and first edge image corresponding to the first target image by utilizing a first generative neural network.

According to a second aspect of the present disclosure, a method of generating an image is provided that is inclusive of steps of
obtaining a second target depth image and second target edge image for image generation;
obtaining a reference color image indicating a reference color feature of the second target depth image and second edge image; and
generating, based on the reference color image, a second depth color image and second edge color image respectively corresponding to the second target depth image and second target edge image by utilizing a second generative neural network.

According to a third aspect of the present disclosure, a method of generating an image is provided that contains steps of
obtaining a first target image for image generation;
obtaining a reference depth image indicating a reference depth feature of the first target image and a reference edge image indicating a reference edge image of the first target image;
generating, based on the reference depth image and reference edge image, a first depth image and first edge image correspond to the first target image by utilizing a first generative neural network; and
generating, based on the first target image, a third depth color image and third edge color image respectively corresponding to the first depth image and first edge image by utilizing a second generative neural network.

According to a fourth aspect of the present disclosure, a method of training a neural network is provided that is inclusive of steps of
inputting a first training target image, a first training depth image indicating a reference depth feature of the first training target image, and a first training edge image indicating a reference edge feature of the first training target image; and
generating, based on the first training depth image and first training edge image, a first training depth generation image and first training edge generation image corresponding to the first training target image by utilizing a first generative neural network, so as to train the first generative neural work and adjust a parameter(s) of the first generative neural network.

According to a fifth aspect of the present disclosure, a method of training a neural network is provided that includes steps of
inputting a second training target depth image and second training target edge image as well as a second training reference color image indicating a reference color feature of the second training target depth image and second training target edge image; and
generating, based on the second training reference color image, a second training depth color image and second training edge color image respectively corresponding to the second training target depth image and second training target edge image by utilizing a second generative neural network, so as to train the second generative neural network and adjust a parameter(s) of the second generative neural network.

According to a sixth aspect of the present disclosure, an apparatus for generating an image is provided that contains
a processor; and
a memory coupled to the processor, storing a computer program,
wherein, the computer program, when executed by the processor, causes the processor to carry out steps of
obtaining a first target image for image generation;
obtaining a reference depth image indicating a reference depth feature of the first target image and a reference edge image indicating a reference edge feature of the first target image; and
generating, based on the reference depth image and reference edge image, a first depth image and first edge image corresponding to the first target image by utilizing a first generative neural network.

According to a seventh aspect of the present disclosure, an apparatus for training a neural network is provided that is inclusive of
a processor; and
a memory coupled to the processor, storing a computer program,
wherein, the computer program, when executed by the processor, causes the processor to conduct steps of
inputting a first training target image, a first training depth image indicating a reference depth feature of the first training target image, and a first training edge image indicating a reference edge feature of the first training target image; and
generating, based on the first training depth image and first training edge image, a first training depth generation image and first training edge generation image corresponding to the first training target image by utilizing a first generative neural network, so as to train the first generative neural work and adjust a parameter(s) of the first generative neural network.

On the basis of the image generation methods and apparatus and neural network training methods and apparatus, it is possible to accomplish mutual reference and flexible conversion among color images, depth images, and edge images in various application scenarios, thereby meeting diverse image generation requirements and attaining varied image generation effects.

Furthermore, based on the above, the embodiments of the present disclosure can achieve defect target generation and defect detection under different image features, so as to enrich the sample data used to train a defect detection neural network. In this way, it is possible to avoid the collection of a large amount of defect data and the process of manual annotation; greatly reduce production cost; ameliorate the accuracy of defect detection; and enhance user experience.

### BRIEF DESCRIPTION OF THE DRAWINGS

FIG. 1 is a flowchart of a method of generating an image in accordance with an embodiment of the present disclosure;

FIG. 2 is a flowchart of a method of generating an image in accordance with an embodiment of the present disclosure;

FIG. 3 is a flowchart of a method of generating an image according to an embodiment of the present disclosure;

FIG. 4 is a flowchart of a method of training a neural network in accordance with an embodiment of the present disclosure;

FIG. 5 is a flowchart of a method of training a neural network in accordance with an embodiment of the present disclosure;

FIG. 6 shows an example of a first target image according to an embodiment of the present disclosure;

FIG. 7 represents an example of a reference depth image according to the embodiment of the present disclosure;

FIG. 8 illustrates an example of a reference edge image according to the embodiment of the present disclosure;

FIG. 9 shows an example of carrying out different processes with respect to the first targe image, reference depth image, and reference edge image, respectively, according to the embodiment of the present disclosure;

FIG. 10 represents examples of a first depth image and first edge image generated respectively, according to the embodiment of the present disclosure;

FIG. 11 illustrates an example of performing different processes on a second target depth image, second target edge image, and reference color image, respectively, in accordance with an embodiment of the present disclosure;

FIG. 12 shows examples of a second depth color image and second edge color image generated respectively, in accordance with the embodiment of the present disclosure;

FIG. 13 represents an example of a first target image according to an embodiment of the present disclosure;

FIG. 14 illustrates an example of a reference depth image according to the embodiment of the present disclosure;

FIG. 15 shows an example of a reference depth image according to the embodiment of the present disclosure;

FIG. 16 represents examples of a first depth image and first edge image generated respectively, according to the embodiment of the present disclosure;

FIG. 17 represents examples of a third depth color image and third edge color image generated respectively, according to the embodiment of the present disclosure;

FIG. 18 shows examples of a third depth color image and third edge color image generated respectively, according to the embodiment of the present disclosure;

FIG. 19 illustrates examples of a third depth color image and third edge color image generated respectively, according to the embodiment of the present disclosure;

FIG. 20 is a block diagram of an apparatus for generating an image in accordance with an embodiment of the present disclosure;

FIG. 21 represents a block diagram of an apparatus for generating an image in accordance with an embodiment of the present disclosure;

FIG. 22 is a block diagram of an apparatus for generating an image in accordance with an embodiment of the present disclosure;

FIG. 23 shows a block diagram of an apparatus for training a neural network according to an embodiment of the present disclosure; and

FIG. 24 is a block diagram of an apparatus for training a neural network according to an embodiment of the present disclosure.

### DESCRIPTION OF THE PREFERRED EMBODIMENTS

In order to let a person skilled in the art better understand the present disclosure, hereinafter, the image generation methods and apparatuses as well as the neural network training methods and apparatuses according to the embodiments of the present disclosure are concretely described with reference to the drawings. However, it should be noted that the same symbols, that are in the specification and drawings, stand for constituent elements having basically the same function and structure, and the repetition of the explanations to the constituent elements is omitted for the sake of convenience.

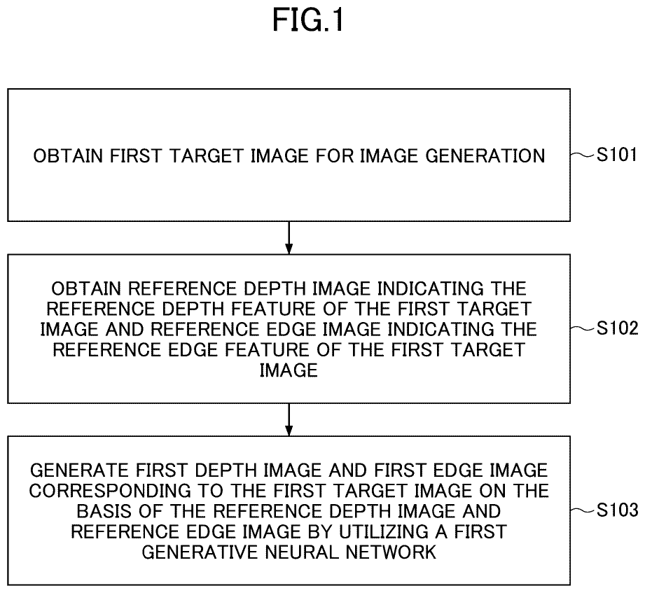

FIG. 1 is a flowchart of a method of generating an image in accordance with an embodiment of the present disclosure. As shown in FIG. 1, the method is inclusive of STEPS S101 to S103.

STEP S101 is obtaining a first target image for image generation.

In the embodiment of the present disclosure, as an option, a first target image for image generation may be a target image containing depth information and/or edge information. For example, optionally, the first target image may be an image with colors (i.e., a color image). In an example, the color mode of the color image may be an RGB (Red, Green, and Blue) mode. Of course, the color mode may also be other color modes such as a CMYK (Cyan, Magenta, Yellow, and Key) mode, HSB (Hue, Saturation, and Brightness) mode, and so on. Here, it should be pointed out that the above examples of the first targe image are merely illustrations. In practical applications, it is also possible to select different forms and contents of the first target image on the basis of the needs of different specific scenarios.

STEP S102 is obtaining a reference depth image (here, a depth image is also called a depth map) indicating the reference depth feature of the first target image and a reference edge image indicating the reference edge feature of the first target image.

In the embodiment of the present disclosure, it is possible to adopt a reference depth image to indicate a reference depth feature to be generated in regard to a first target image. Moreover, it is also possible to adopt a reference edge image to indicate a reference edge feature to be generated in regard to the first target image. For example, the reference depth feature indicated by the reference depth image may include the foreground depth feature, background depth feature, etc., of an image to be generated. The reference edge feature indicated by the reference edge image may include the edge line feature, edge thickness, etc., of an image to be generated.

STEP S103 is generating a first depth image and first edge image corresponding to the first target image on the basis of the reference depth image and reference edge image by utilizing a first generative neural network.

In the embodiment of the present disclosure, optionally, it is possible to first carry out processes with respect to one or more of a first target image, reference depth image, and reference edge image, and then, generate a first depth image and first edge image on the basis of the processed images.

In the embodiment of the present disclosure, as an option, the processes performed on one or more of a first target image, reference depth image, and reference edge image may be inclusive of enhancement processing and/or editing processing. Optionally, the enhancement processing may include one or more operations of image distortion, image flipping, image rotation, image cropping, edge adjustment, image translation, and image scaling in regard to the global or local region of at least one relevant image. The editing processing may include dividing at least one relevant image into regions on the basis of its semantics and/or shape and conducting one or more operations of adding, deleting, and modifying on each of the divided regions.

In the embodiment of the present disclosure, optionally, the processes carried out with respect to a first target image, reference depth image, and/or reference edge image may be the same or different. For example, it is possible to randomly select the processes performed on the first target image, reference depth image, and/or reference edge image or the relating parameters used for image processing on the first target image, reference depth image, and/or reference edge image, respectively. Furthermore, as an option, the processes conducted on the first target image, reference depth image, and/or reference edge image may be performed on the global or local region of at least one relevant image, and different processing approaches may be selected for the different or identical regions in the relevant image, or the different processing approaches may be combined. For example, when carrying out region selection and region editing with respect to at least one relevant image, it is possible to first conduct region division in regard to the relevant image according to its shape or semantics, and then, randomly select several divided regions. Subsequently, in the selected regions, various editing operations, including but not limited to adding, deleting, and modifying edges, may be implemented, and the edited result may be input into a first generative neural network for the follow-on steps. In one example, when dividing a relevant image into regions on the basis of its semantics, a pre-trained semantic segmentation model may be utilized to obtain the corresponding semantic regions of the relevant image. In addition, when dividing a relevant image into regions on the basis of its shape, it is possible to carry out the region division in accordance with a predetermined shape having different sizes (e.g., rectangles with different aspect ratios), so as to acquire a plurality of large continuous regions or small discrete regions that may then be processed later.

In the embodiment of the present disclosure, it is possible to generate, based on the obtained first target image as well as the reference depth feature provided by the obtained reference depth image, a corresponding first depth image by utilizing a first generative neural network. Additionally, it is also possible to generate, based on the obtained first target image as well as the reference edge feature provided by the obtained reference edge image, a corresponding first edge image by utilizing the first generative neural network. As an option, after processing the first target image, the first depth image may be generated on the basis of the reference depth feature in the reference depth image. Similarly, after processing the first target image, the first edge image may be generated on the basis of the reference edge feature in the reference edge image. For example, the generated first depth image and/or first edge image may be used in the sample training process of a neural network for defect detection and various application scenarios such as image generation and feature extraction of different categories of items (objects), and the like.

On the basis of the image generation method in accordance with the embodiment of the present disclosure, it is possible to accomplish mutual reference and flexible conversion among color images, depth images, and edge images in various application scenarios, thereby satisfying different image generation requirements and attaining various image generation effects.

Furthermore, based on the above, the embodiment of the present disclosure can achieve defect target generation under different image features, so as to enrich the sample data for training a defect detection neural network. In this way, it is possible to avoid the collection of a large amount of defect data and the process of manual annotation; dramatically reduce production cost; ameliorate the accuracy of defect detection; and make user experience better.

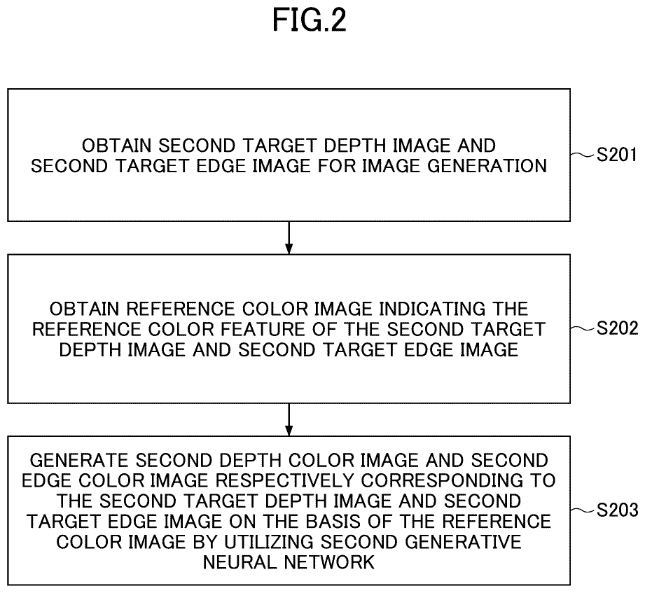

FIG. 2 is a flowchart of a method of generating an image in accordance with an embodiment of the present disclosure. As illustrated in FIG. 2, the method includes STEPS S201 to S203.

STEP S201 is obtaining a second target depth image and second target edge image for image generation.

In the embodiment of the present disclosure, the obtained second targe depth image may have the depth information of a relevant image to be generated, and the obtained second targe edge image may have the edge information of the relevant image to be generated.

STEP S202 is obtaining a reference color image indicating the reference color feature of the second target depth image and second target edge image.

In the embodiment of the present disclosure, it is possible to utilize a reference color image to indicate a reference color feature to be generated with respect to a second target depth image and/or second target edge image. For example, optionally, the color mode indicated by the reference color feature of the reference color image may be an RGB mode. Of course, the color mode may also be other color modes such as a CMYK mode, HSB mode, and so forth. Here, it should be mentioned that the above examples of the reference color image are just illustrations. In practical applications, it is also possible to select different forms and contents of the reference color image on the basis of the needs of different concrete scenarios.

STEP S203 is generating a second depth color image and second edge color image respectively corresponding to the second target depth image and second target edge image on the basis of the reference color image by utilizing a second generative neural network.

In the embodiment of the present disclosure, as an option, it is possible to first perform processes on one or more of a reference color image, second target depth image, and second target edge image, respectively, and then, generate a second depth color image and second edge color image on the basis of the processed images.

In the embodiment of the present disclosure, optionally, the processes conducted on one or more of a reference color image, second target depth image, and second target edge image may include enhancement processing and/or editing processing. As an option, the enhancement processing may be inclusive of one or more operations of image distortion, image flipping, image rotation, image cropping, edge adjustment, image translation, and image scaling about the global or local region of at least one relevant image. Additionally, the editing processing may be inclusive of dividing at least one relevant image into regions on the basis of the semantics and/or shape of the relevant image and conducting one or more operations of adding, deleting, and modifying on each of the divided regions.

In the embodiment of the present disclosure, optionally, the processes carried out with respect to a reference color image, second target depth image, and/or second target edge image may be the same or different. For example, it is possible to randomly select the processes conducted on the reference color image, second target depth image, and/or second target edge image or the relating parameters used for image processing on the reference color image, second target depth image and/or second target edge image. Moreover, as an option, the processes performed on the reference color image, second target depth image and/or second target edge image may be conducted on the global or local region of at least one relevant image, and different processing approaches may be selected for the different or identical regions in the relevant image, or the different processing approaches may be combined. For example, when carrying out region selection and region editing with respect to at least one relevant image, it is possible to first conduct region division in regard to the relevant image according to its shape or semantics, and then, randomly select several divided regions. Subsequently, in the selected regions, various editing operations, including but not limited to adding, deleting, and modifying edges, may be implemented, and the edited result may be input into a second generative neural network for the follow-on steps. In one example, when dividing a relevant image into regions on the basis of its semantics, a pre-trained semantic segmentation model may be utilized to obtain the corresponding semantic regions of the relevant image. In addition, when dividing a relevant image into regions on the basis of its shape, it is possible to carry out the region division in accordance with a predetermined shape having different sizes (e.g., rectangles with different aspect ratios), so as to acquire a plurality of large continuous regions or small discrete regions serving as the follow-on processing objects.

In the embodiment of the present disclosure, it is possible to generate, based on the obtained second target depth image as well as the reference color feature provided by the obtained reference color image, a corresponding second depth color image by utilizing a second generative neural network. In addition, it is also possible to generate, based on the obtained second target edge image as well as the reference color feature provided by the obtained reference color image, a corresponding second edge color image by utilizing the second generative neural network. Optionally, after processing the second target depth image, the second depth color image may be generated on the basis of the reference color feature in the reference color image. Similarly, after processing the second target edge image, the second edge color image may be generated on the basis of the reference color feature in the reference color image. For example, the generated second depth color image and/or second edge color image may be used in the sample training process of a neural network for defect detection and various application scenarios such as image generation and feature extraction of different categories of items (objects), and so on.

On the basis of the image generation method in accordance with the embodiment of the present disclosure, it is possible to achieve mutual reference and flexible conversion among color images, depth images, and edge images in different application scenarios, thereby fulfilling varied image generation requirements and acquiring various image generation effects.

Moreover, based on the above, the embodiment of the present disclosure can accomplish defect target generation under different image features, so as to enrich the sample data for training a defect detection neural network. In this way, it is possible to avoid the collection of a large amount of defect data and the process of manual annotation; greatly reduce production cost; improve the accuracy of defect detection; and ameliorate user experience.

In the embodiment of the present disclosure, it is also possible to create more complete and richer images by combining the image generation method shown in FIG. 1 (in which a first target image is utilized to generate a first depth image and first edge image) and the image generation method represented in FIG. 2 (in which a second target depth image and second target edge image are utilized to generate a second depth color image and second edge color image).

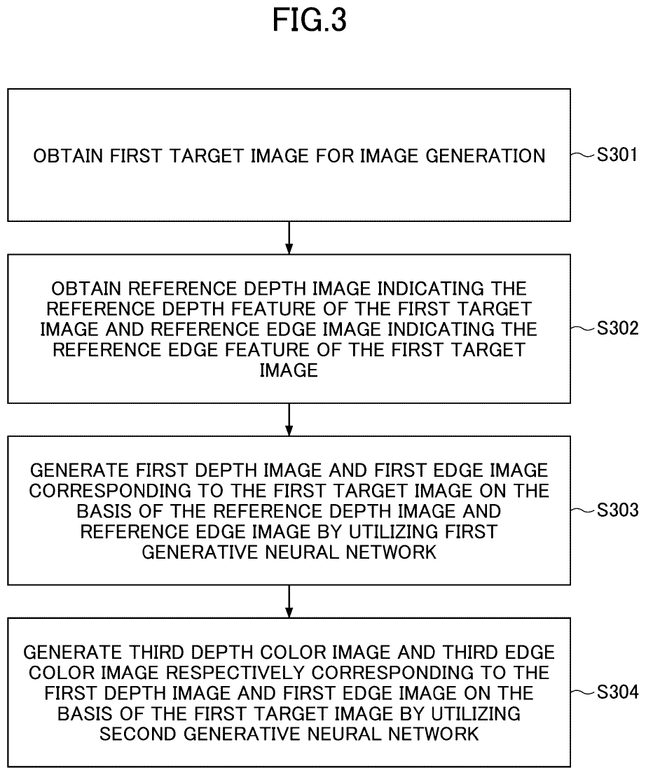

FIG. 3 is a flowchart of a method of generating an image in accordance with an embodiment of the present disclosure. As represented in FIG. 3, the method includes STEPS S301 to S304.

STEP S301 is obtaining a first target image for image generation.

In the embodiment of the present disclosure, as an option, a first target image for image generation may be a target image containing depth information and/or edge information. For example, optionally, the first target image may be an image with colors (i.e., a color image). In an example, the color mode of the color image may be an RGB mode. Of course, the color mode may also be other color modes such as a CMYK mode, HSB mode, and the like. Here, it should be noted that the above examples of the first targe image are merely illustrations. In practical applications, it is also possible to select different forms and contents of the first target image on the basis of the needs of different specific scenarios.

STEP S302 is obtaining a reference depth image indicating the reference depth feature of the first target image and a reference edge image indicating the reference edge feature of the first target image.

In the embodiment of the present disclosure, it is possible to utilize a reference depth image to indicate a reference depth feature to be generated in regard to a first target image. Moreover, it is also possible to utilize a reference edge image to indicate a reference edge feature to be generated in regard to the first target image. For example, the reference depth feature indicated by the reference depth image may include the foreground depth feature, background depth feature, etc., of an image to be generated. The reference edge feature indicated by the reference edge image may include the edge line feature, edge thickness, etc., of an image to be generated.

STEP S303 is generating a first depth image and first edge image corresponding to the first target image on the basis of the reference depth image and reference edge image by utilizing a first generative neural network.

In the embodiment of the present disclosure, optionally, it is possible to first carry out processes with respect to one or more of a first target image, reference depth image, and reference edge image, and then, generate a first depth image and first edge image on the basis of the processed images.

In the embodiment of the present disclosure, as an option, the processes performed on one or more of a first target image, reference depth image, and reference edge image may be inclusive of enhancement processing and/or editing processing. Optionally, the enhancement processing may include one or more operations of image distortion, image flipping, image rotation, image cropping, edge adjustment, image translation, and image scaling in regard to the global or local region of at least one relevant image. Moreover, the editing processing may include dividing at least one relevant image into regions on the basis of the semantics and/or shape of the relevant image and conducting one or more operations of adding, deleting, and modifying on each of the divided regions.

In the embodiment of the present disclosure, optionally, the processes carried out with respect to a first target image, reference depth image, and/or reference edge image may be the same or different. For example, it is possible to randomly select the processes performed on the first target image, reference depth image, and/or reference edge image or the relating parameters used for image processing on the first target image, reference depth image, and/or reference edge image, respectively. Furthermore, as an option, the processes conducted on the first target image, reference depth image, and/or reference edge image may be performed on the global or local region of at least one relevant image, and different processing approaches may be selected for the different or identical regions in the relevant image, or the different processing approaches may be combined. For example, when carrying out region selection and region editing with respect to at least one relevant image, it is possible to first conduct region division in regard to the relevant image according to its shape or semantics, and then, randomly select several divided regions. Subsequently, in the selected regions, various editing operations, including but not limited to adding, deleting, and modifying edges, may be implemented, and the edited result may be input into a first generative neural network for the follow-on steps. In one example, when dividing a relevant image into regions on the basis of its semantics, a pre-trained semantic segmentation model may be utilized to obtain the corresponding semantic regions of the relevant image. In addition, when dividing a relevant image into regions on the basis of its shape, it is possible to carry out the region division in accordance with a predetermined shape having different sizes (e.g., rectangles with different aspect ratios), so as to acquire a plurality of large continuous regions or small discrete regions that may then be processed later.

In the embodiment of the present disclosure, it is possible to generate, based on the obtained first target image as well as the reference depth feature provided by the obtained reference depth image, a corresponding first depth image by utilizing a first generative neural network. Additionally, it is also possible to generate, based on the obtained first target image as well as the reference edge feature provided by the obtained reference edge image, a corresponding first edge image by utilizing the first generative neural network. As an option, after processing the first target image, the first depth image may be generated on the basis of the reference depth feature in the reference depth image. Similarly, after processing the first target image, the first edge image may be generated on the basis of the reference edge feature in the reference edge image.

STEP S304 is generating a third depth color image and third edge color image respectively corresponding to the first depth image and first edge image on the basis of the first target image by utilizing a second generative neural network.

In the embodiment of the present disclosure, it is possible to further utilize a first target image to indicate a reference color feature to be generated with respect to a first depth image and/or first edge image.

Optionally, it is also possible to first conduct processes on one or more of a first target image, first depth image, and first edge image, respectively, and then, generate a third depth color image and third edge color image on the basis of the processed images.

In the embodiment of the present disclosure, as an option, the processes performed on one or more of a first target image, first depth image, and first edge image may be inclusive of enhancement processing and/or editing processing. Optionally, the enhancement processing may include one or more operations of image distortion, image flipping, image rotation, image cropping, edge adjustment, image translation, and image scaling in regard to the global or local region of at least one relevant image. Furthermore, the editing processing may include dividing at least one relevant image into regions on the basis of the semantics and/or shape of the relevant image and conducting one or more operations of adding, deleting, and modifying on each of the divided regions.

In the embodiment of the present disclosure, optionally, the processes carried out with respect to a first target image, first depth image, and/or first edge image may be the same or different. For example, it is possible to randomly select the processes performed on the first target image, first depth image, and/or first edge image or the relating parameters used for image processing on the first target image, first depth image, and/or first edge image, respectively. Furthermore, as an option, the processes conducted on the first target image, first depth image, and/or first edge image may be performed on the global or local region of at least one relevant image, and different processing approaches may be selected for the different or identical regions in the relevant image, or the different processing approaches may be combined. For example, when carrying out region selection and region editing with respect to at least one relevant image, it is possible to first conduct region division in regard to the relevant image according to its shape or semantics, and then, randomly select several divided regions. Subsequently, in the selected regions, various editing operations, including but not limited to adding, deleting, and modifying edges, may be implemented, and the edited result may be input into a second generative neural network for the follow-on steps. In one example, when dividing a relevant image into regions on the basis of its semantics, a pre-trained semantic segmentation model may be utilized to obtain the corresponding semantic regions of the relevant image. In addition, when dividing a relevant image into regions on the basis of its shape, it is possible to carry out the region division in accordance with a predetermined shape having different sizes (e.g., rectangles with different aspect ratios), so as to acquire a plurality of large continuous regions or small discrete regions that may then be processed later.

In the embodiment of the present disclosure, it is possible to generate, based on the obtained first depth image as well as the reference color feature provided by the obtained first target image, a corresponding third depth color image by utilizing a second generative neural network. Additionally, it is also possible to generate, based on the obtained first edge image as well as the reference color feature provided by the obtained first target image, a corresponding third edge color image by utilizing the second generative neural network. As an option, after processing the first depth image, the third depth color image may be generated on the basis of the reference color feature in the first target image. Similarly, after processing the first edge image, the third edge color image may be generated on the basis of the reference color feature in the first target image. For example, the generated third depth color image and/or third edge color image may be used in the sample training process of a neural network for defect detection and in various application scenarios such as image generation and feature extraction of different categories of items (objects), and the like.

On the basis of the image generation method in accordance with the embodiment of the present disclosure, it is possible to accomplish mutual reference and flexible conversion among color images, depth images, and edge images in different application scenarios, thereby fulfilling varied image generation requirements and acquiring various image generation effects.

Moreover, based on the above, the embodiment of the present disclosure can achieve defect target generation under different image features, so as to enrich the sample data for training a defect detection neural network. In this way, it is possible to avoid the collection of a large amount of defect data and the process of manual annotation; greatly reduce production cost; improve the accuracy of defect detection; and make user experience better.

Additionally, it is also possible to provide samples needed to simulate various defects by utilizing the image generation methods in accordance with the embodiments of the present disclosure, so as to train a generative neural network.

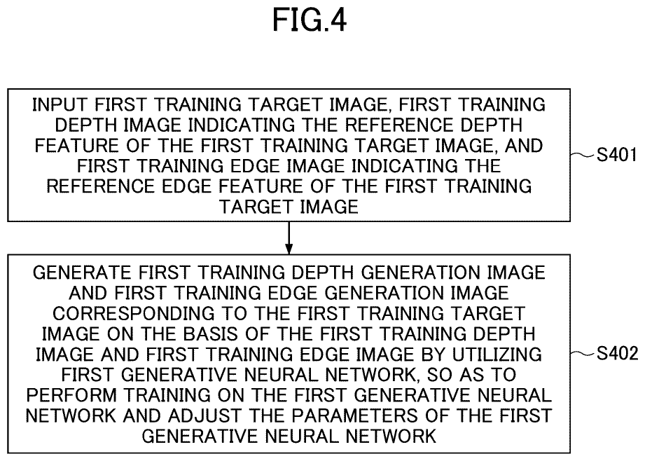

FIG. 4 is a flowchart of a method of training a neural network in accordance with an embodiment of the present disclosure. As shown in FIG. 4, the method is inclusive of STEPS S401 and S402.

STEP S401 is inputting a first training target image, a first training depth image indicating the reference depth feature of the first training target image, and a first training edge image indicating the reference edge feature of the first training target image.

In the embodiment of the present disclosure, as an option, a first training target image for neural network training may be a training target image containing depth information and/or edge information. For example, optionally, the first training target image may be an image with colors (i.e., a color image). In an example, the color mode of the color image may be an RGB mode. Of course, the color mode may also be other color modes such as a CMYK mode, HSB mode, and so on. Here, it should be pointed out that the above examples of the first training targe image are merely illustrations. In practical applications, it is also possible to select different forms and contents of the first training target image on the basis of the needs of different specific scenarios.

In the embodiment of the present disclosure, it is possible to utilize a first training target depth image to indicate a reference depth feature to be generated for to a first training target image. Moreover, it is also possible to utilize a first training edge image to indicate a reference edge feature to be generated for the first training target image. For example, the reference depth feature indicated by the first training depth image may include the foreground depth feature, background depth feature, etc., of an image to be generated. The reference edge feature indicated by the first training edge image may include the edge line feature, edge thickness, etc., of an image to be generated.

STEP S402 is generating a first training depth generation image and first training edge generation image corresponding to the first training target image on the basis of the first training depth image and first training edge image by utilizing a first generative neural network, so as to perform training on the first generative neural network and adjust a parameter(s) of the first generative neural network.

In the embodiment of the present disclosure, optionally, it is possible to first conduct processes with respect to one or more of a first training targe image, first training depth image, and first training edge image, respectively, and then, generate a first training depth generation image and first training edge generation image on the basis of the processed images.

In the embodiment of the present disclosure, as an option, the processes performed on one or more of a first training target image, first training depth image, and first training edge image may be inclusive of enhancement processing and/or editing processing. Optionally, the enhancement processing may include one or more operations of image distortion, image flipping, image rotation, image cropping, edge adjustment, image translation, and image scaling in regard to the global or local region of at least one relevant image. The editing processing may include dividing at least one relevant image into regions on the basis of the semantics and/or shape of the relevant image and conducting one or more operations of adding, deleting, and modifying on each of the divided regions.

In the embodiment of the present disclosure, optionally, the processes carried out with respect to a first training target image, first training depth image, and/or first training edge image may be the same or different. For example, it is possible to randomly select the processes performed on the first training target image, first training depth image, and/or first training edge image or the relating parameters used for processing the first training target image, first training depth image, and/or first training edge image, respectively. Furthermore, as an option, the processes conducted on the first training target image, first training depth image, and/or first training edge image may be performed on the global or local region of at least one relevant image, and different processing approaches may be selected for the different or identical regions in the relevant image, or the different processing approaches may be combined. For example, when carrying out region selection and region editing with respect to at least one relevant image, it is possible to first conduct region division in regard to the relevant image according to its shape or semantics, and then, randomly select several divided regions. Subsequently, in the selected regions, various editing operations, including but not limited to adding, deleting, and modifying edges, may be implemented, and the edited result may be input into a first generative neural network for the follow-on steps. In one example, when dividing a relevant image into regions on the basis of its semantics, a pre-trained semantic segmentation model may be utilized to obtain the corresponding semantic regions of the relevant image. In addition, when dividing a relevant image into regions on the basis of its shape, it is possible to carry out the region division in accordance with a predetermined shape having different sizes (e.g., rectangles with different aspect ratios), so as to acquire a plurality of large continuous regions or small discrete regions that may then be processed later.

In the embodiment of the present disclosure, it is possible to generate, based on the obtained first training target image as well as the reference depth feature provided by the obtained first training depth image, a corresponding first training depth generation image by utilizing a first generative neural network. Additionally, it is also possible to generate, based on the obtained first training target image as well as the reference edge feature provided by the obtained first training edge image, a corresponding first training edge generation image by utilizing the first generative neural network. As an option, after processing the first training target image, the first training depth generation image may be generated on the basis of the reference depth feature in the first training depth image. Similarly, after processing the first training target image, the first training edge generation image may be generated on the basis of the reference edge feature in the first training edge image. For example, the generated first training depth generation image and/or first training edge generation image may be used in the sample training process of a first generative neural network for defect detection.

After acquiring the first training depth generation image and first training edge generation image, it is possible to train a first generative neural network and adjust a parameter(s) of the first generative neural network on the basis of the first training depth generation image and first training edge generation image, so as to let the parameter(s) of the first generative neural network converge. For example, the original images input into the first generative neural network may be used as ground truth and compared with the first training depth generation image and first training edge generation image, in which various types of defects (e.g., depth defects, edge defects, color defects, and texture defects) have been introduced, so as to train the first generative neural network and adjust its parameter(s).

On the basis of the neural network training method in accordance with the embodiment of the present disclosure, it is possible to accomplish defect target generation under different image features, so as to enrich the sample data for training a defect detection neural network. In this way, it is possible to avoid the collection of a large amount of defect data and the process of manual annotation; greatly reduce production cost; improve the accuracy of defect detection; and ameliorate user experience.

FIG. 5 is a flowchart of a method of training a neural network in accordance with an embodiment of the present disclosure. As represented in FIG. 5, the method includes STEPS S501 and S502.

STEP S501 is inputting a second training target depth image and second training target edge image as well as a second training reference color image being indicative of the reference color feature of the second training target depth image and second training target edge image.

In the embodiment of the present disclosure, the input second training target depth image may have the depth information of a relevant image to be generated, and the input second training target edge image may have the edge information of a relevant image to be generated.

In the embodiment of the present disclosure, it is possible to utilize a second training reference color image to indicate a reference color feature to be generated with respect to a second training target depth image and/or second training target edge image. For example, optionally, the color mode indicated by the reference color feature of the second training reference color image may be an RGB mode. Of course, the color mode may also be other color modes such as a CMYK mode, HSB mode, and so forth. Here, it should be mentioned that the above examples of the second training reference color image are just exemplary ones. In practical applications, it is also possible to select different forms and contents of the second training reference color image on the basis of the needs of different specific scenarios.

STEP S502 is generating a second training depth color image and second training edge color image respectively corresponding to the second training target depth image and second training target edge image on the basis of the second training reference color image by utilizing a second generative neural network, so as to perform training on the second generative neural network and adjust a parameter(s) of the second generative neural network.

In the embodiment of the present disclosure, as an option, it is possible to first conduct processes on one or more of a second training reference color image, second training target depth image, and second training target edge image, respectively, and then, generate a second training depth color image and second training edge color image on the basis of the processed images.

In the embodiment of the present disclosure, optionally, the processes performed on one or more of a second training reference color image, second training target depth image, and second training target edge image may be inclusive of enhancement processing and/or editing processing. As an option, the enhancement processing may include one or more operations of image distortion, image flipping, image rotation, image cropping, edge adjustment, image translation, and image scaling in regard to the global or local region of at least one relevant image. The editing processing may include dividing at least one relevant image into regions on the basis of the semantics and/or shape of the relevant image and conducting one or more operations of adding, deleting, and modifying on each of the divided regions.

In the embodiment of the present disclosure, optionally, the processes carried out with respect to a second training reference color image, second training target depth image, and/or second training target edge image may be the same or different. For example, it is possible to randomly select the processes performed on the second training reference color image, second training target depth image, and/or second training target edge image or the relating parameters adopted in regard to the second training reference color image, second training target depth image, and/or second training target edge image, respectively. Furthermore, as an option, the processes conducted on the second training reference color image, second training target depth image, and/or second training target edge image may be performed on the global or local region of at least one relevant image, and different processing approaches may be selected for the different or identical regions in the relevant image, or the different processing approaches may be combined. For example, when carrying out region selection and region editing with respect to at least one relevant image, it is possible to first conduct region division in regard to the relevant image according to its shape or semantics, and then, randomly select several divided regions. Subsequently, in the selected regions, various editing operations, including but not limited to adding, deleting, and modifying edges, may be implemented, and the edited result may be input into a second generative neural network for the follow-on steps. In one example, when dividing a relevant image into regions on the basis of its semantics, a pre-trained semantic segmentation model may be utilized to obtain the corresponding semantic regions of the relevant image. In addition, when dividing a relevant image into regions on the basis of its shape, it is possible to carry out the region division in accordance with a predetermined shape having different sizes (e.g., rectangles with different aspect ratios), so as to acquire a plurality of large continuous regions or small discrete regions that may then be processed later.

In the embodiment of the present disclosure, it is possible to generate, based on the obtained second training target depth image as well as the reference color feature provided by the obtained second training reference color image, a corresponding second training depth color image by utilizing a second generative neural network. In addition, it is also possible to generate, based on the obtained second training target edge image as well as the reference color feature provided by the obtained second training reference color image, a corresponding second training edge color image by utilizing the second generative neural network. Optionally, after processing the second training target depth image, the second training depth color image may be generated on the basis of the reference color feature in the second training reference color image. Similarly, after processing the second training target edge image, the second training edge color image may be generated on the basis of the reference color feature in the second training reference color image. For example, the generated second training depth color image and/or second training edge color image may be used in the sample training process of a second generative neural network for defect detection.

After acquiring the second training depth color image and second training edge color image, it is possible to train a second generative neural network and adjust a parameter(s) of the second generative neural network on the basis of the second training depth color image and second training edge color image, so as to let the parameter(s) of the second generative neural network converge. For example, the original images input into the second generative neural network may be used as ground truth and compared with the second training depth color image and second training edge color image, in which various types of defects (e.g., depth defects, edge defects, color defects, and texture defects) have been introduced, so as to train the second generative neural network and adjust its parameter(s).

On the basis of the neural network training method in accordance with the embodiment of the present disclosure, it is possible to achieve defect target generation under different image features, so as to enrich the sample data for training a defect detection neural network. In this way, it is possible to avoid the collection of a large amount of defect data and the process of manual annotation; greatly reduce production cost; ameliorate the accuracy of defect detection; and improve user experience.

In the embodiment of the present disclosure, it is also possible to further utilize, after utilizing the first training target image to generate the first training depth generation image and first training edge generation image in FIG. 4, the first training depth generation image and first training edge generation image to generate corresponding color images in conjunction with FIG. 5, so as to generate more complete and richer defect images for neural network training, thereby accomplishing a more accurate and efficient neural network training process. The specific steps are described above and not elaborated here.

Hereinafter, an exemplary image generation method in accordance with an embodiment of the present disclosure is provided.

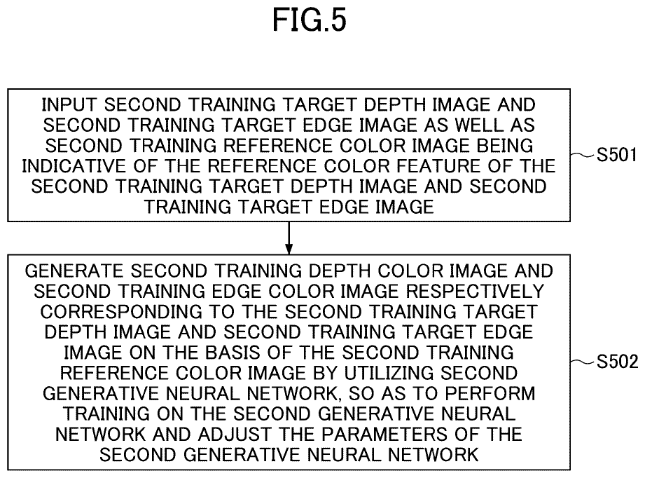

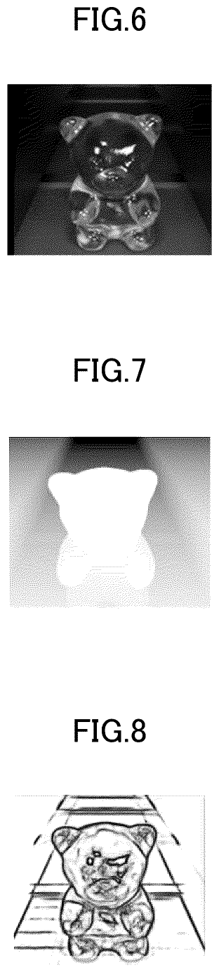

According to an example of the embodiment of the present disclosure, a first target image for image generation may be obtained first. FIG. 6 shows an exemplary first target image in this example. As shown in FIG. 6, the first target image may be an image with colors (i.e., a color image). In this example, the color mode of the color image may be an RGB mode.

Then, it is possible to obtain a reference depth image indicating the reference depth feature of the first target image as well as a reference edge image indicating the reference edge feature of the first target image, respectively. FIG. 7 represents an exemplary reference depth image in this example. FIG. 8 illustrates an exemplary reference edge image in this example. As shown in FIGS. 7 and 8, the reference depth feature indicated by the reference depth image may include the foreground depth feature, background depth feature, etc., of an image to be generated. The reference edge feature indicated by the reference edge image may include the edge line feature, edge thickness, etc., of an image to be generated.

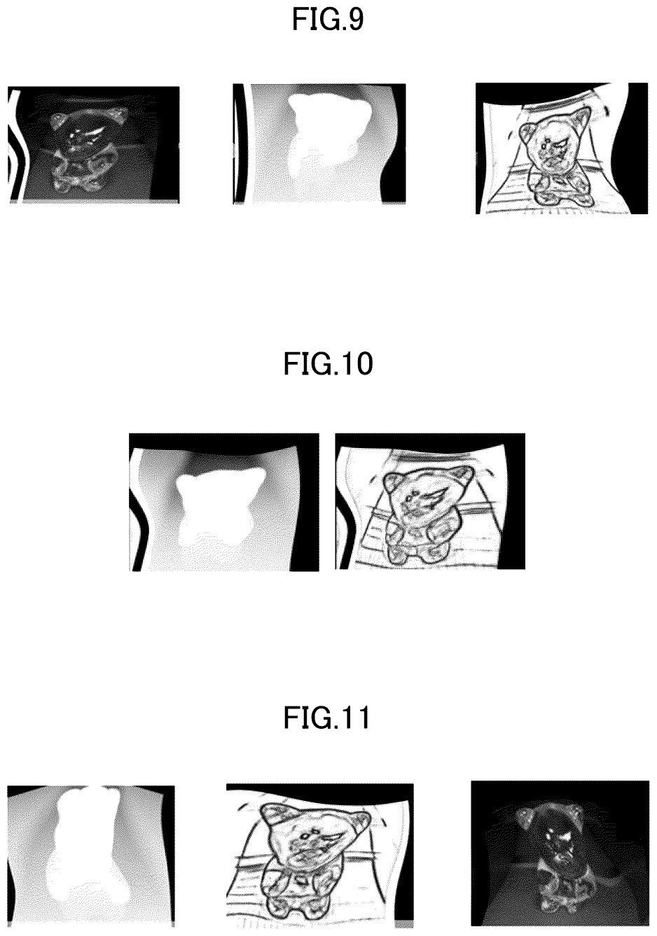

In this example, processes may be performed on one or more of the first target image, reference depth image, and reference edge image, respectively. FIG. 9 shows an exemplary process of carrying out different processes with respect to the first targe image, reference depth image, and reference edge image, respectively. In FIG. 9, the processing results about the first target image, reference depth image, and reference edge image are represented from left to right, respectively. The processing approaches for the respective images may be randomly selected and specifically include local distortion and deformation, flipping, cropping, and zero-padding operations. The relevant parameters of the processing approaches may also be chosen randomly. Specifically, taking the local distortion and deformation operation as an example, it may be conducted by selecting a local region in the relating image and dividing it into grid; randomly choosing several nodes in the grid; randomly performing horizonal and vertical translation on these nodes; and carrying out processes (such as bending deformation, flipping, cropping, zero-padding, and the like) in regard to the first target image, reference depth image, and reference edge image, respectively, so as to acquire a new set of a first target image, reference depth image, and reference edge image.

Next, it is possible to generate a first depth image and first edge image respectively corresponding to the first target image on the basis of the reference depth image and reference edge image by utilizing a first generative neural network.

In this example, after processing the first target image, the first depth image may be generated on the basis of the reference depth feature in the reference depth image. Similarly, after processing the first target image, the first edge image may be generated on the basis of the reference edge feature in the reference edge image. FIG. 10 represents a first depth image and first edge image generated respectively in this example. In FIG. 10, a firs depth image generated on the basis of the first target image together with the reference depth image and a first edge image generated on the basis of the first target image together with the reference edge image are illustrated from left to right.

In what follows, another exemplary image generation method in accordance with an embodiment of the present disclosure is provided.

According to an example of the embodiment of the present disclosure, it is possible to first obtain a second target depth image and second target edge image for image generation. In this example, contrary to the previous example, the depth image and edge image shown in FIGS. 7 and 8 may be used as the second target depth image and second target edge image, respectively.

Then, a reference color image, that indicates the reference color feature of the second target depth image and second target edge image, may be obtained. In this example, it is possible to let the color image represented in FIG. 6 be the reference color image, for example. The color mode of the color image in FIG. 6 may be an RGB mode.

After obtaining the second target depth image, second target edge image, and reference color image, respectively, processes may be conducted on one or more of these images. FIG. 11 illustrates an exemplary process of performing different processes on the second target depth image, second target edge image, and reference color image, respectively. In FIG. 11, the processing results about the second target depth image, second target edge image, and reference color image are illustrated from left to right, respectively. The processing approaches with respect to the respective images may be randomly selected and specifically include local distortion and deformation, flipping, cropping, and zero-padding operations. The relevant parameters of the processing approaches may also be chosen randomly. Here, the processes carried out in regard to the second target depth image, second target edge image, and reference color image, respectively may be different from the processes in the previous example.

Next, after processing the respective images, it is possible to generate a second depth color image and second edge color image respectively corresponding to the second target depth image and second target edge image on the basis of the reference color image by utilizing a second generative neural network.

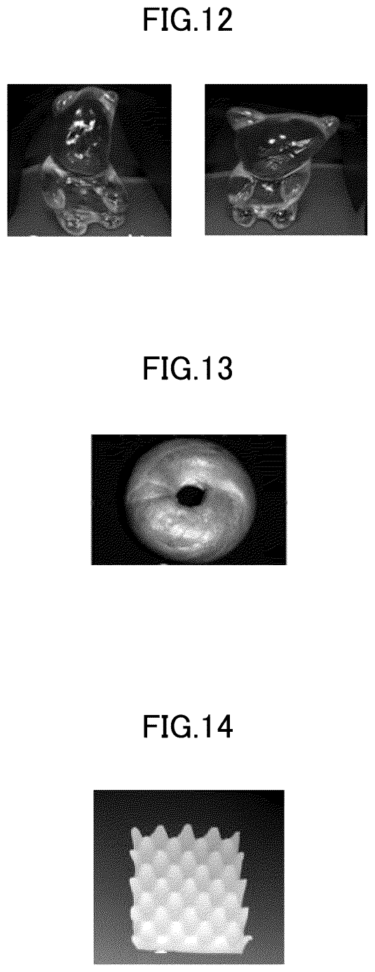

In this embodiment, after processing the second target depth image and second target edge image, on the basis of the color feature of the reference color image, it is possible to utilize the second generative neural network to generate the second depth color image and second edge color image, respectively. FIG. 12 shows examples of a second depth color image and second edge color image generated respectively in this example. In FIG. 12, a second depth color image generated based on the second target depth image together with the reference color image and a second edge color image generated based on the second target edge image together with the reference color image are shown from left to right, respectively.

Hereinafter, still another exemplary image generation method in accordance with an embodiment of the present disclosure is provided.

According to an example of the embodiment of the present disclosure, a first target image for image generation may be obtained first. FIG. 13 represents an exemplary first target image in this example. As shown in FIG. 13, the first target image may be an image with colors (i.e., a color image). In this example, the color mode of the color image may be an RGB mode.

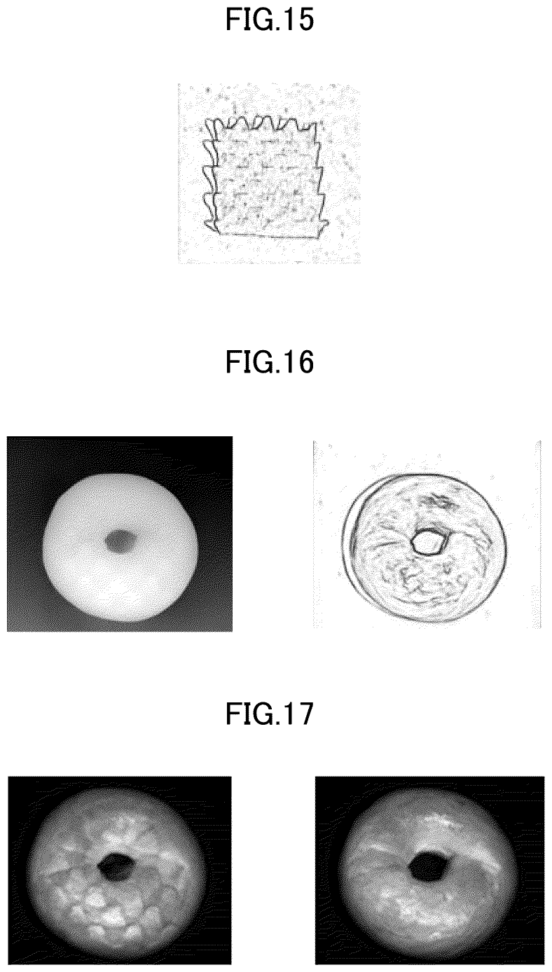

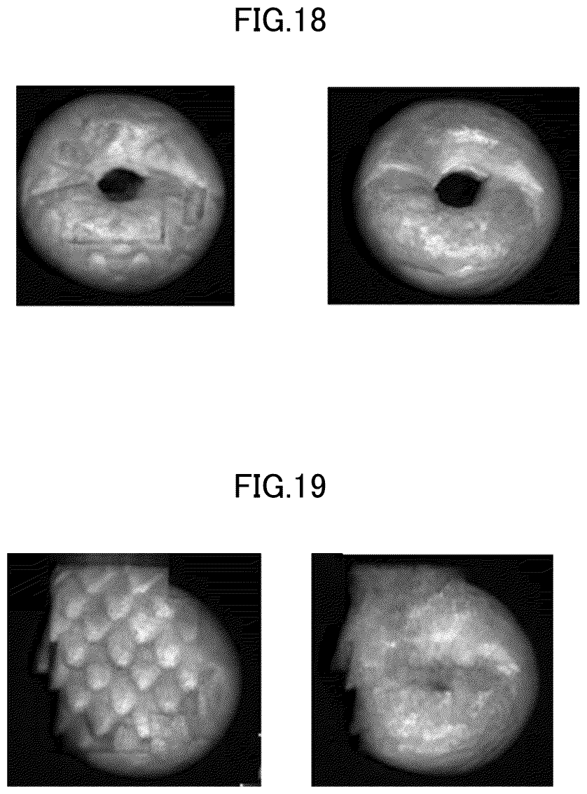

Then, it is possible to obtain a reference depth image indicating the reference depth feature of the first target image as well as a reference edge image indicating the reference edge feature of the first target image. FIG. 14 illustrates an exemplary reference depth image in this example. FIG. 15 shows an exemplary reference edge image in this example. As represented in FIGS. 14 and 15, the reference depth feature indicated by the reference depth image may include the foreground depth feature, background depth feature, etc., of an image to be generated. The reference edge feature indicated by the reference edge image may include the edge line feature, edge thickness, etc., of an image to be generated.

In this example, a first depth image and first edge image corresponding to the first target image may be generated on the basis of the reference depth image and reference edge image by taking advantage of a first generative neural network. FIG. 16 represents a first depth image and first edge image generated respectively in this example. In FIG. 16, a first depth image generated on the basis of the first target image together with the reference depth image and a first edge image generated on the basis of the first target image together with the reference edge image are illustrated from left to right.

Next, it is possible to further generate a third depth color image and third edge color image respectively corresponding to the first depth image and first edge image on the basis of the first target image by making use of a second generative neural network.

Here, the first target image may be utilized to indicate a reference color feature to be generated with respect to the first depth image and/or first edge image. In other words, it is possible to generate a third depth color image and third edge color image respectively corresponding to the first depth image and first edge image on the basis of the first target image by means of the second generative neural network. FIG. 17 represents a third depth color image and third edge color image generated respectively in this example. In FIG. 17, a third depth color image generated on the basis of the first depth image together with the first target image and a third edge color image generated on the basis of the first edge image together with the first target image are illustrated from left to right.

In this example, it is also possible to carrying out, before generating a third depth color image and third edge color image, various enhancement and/or editing operations in regard to a first target image, first depth image and/or first edge image in the intermediate state, respectively. For example, it is possible to conduct, before generating the first depth image and first edge image, early processing with respect to one or more of the first target image, first depth image, and first edge image, and the eventually obtained examples of the third depth color image and third edge color image are shown in FIG. 8. Again, for example, it is also possible to perform, after generating the first depth image and first edge image, follow-on processing on one or more of the first target image, first depth image, and first edge image, and the finally acquired examples of the third depth color image and third edge color image are represented in FIG. 9.

In the various examples of the embodiments of the present disclosure, after obtaining various images that have undergone processes such as feature extraction, enhancement, editing, and so on, the generated images at the respective stages may be used as training samples for training a neural network and adjusting is parameter(s). The specific training methods are described above and not repeated here.

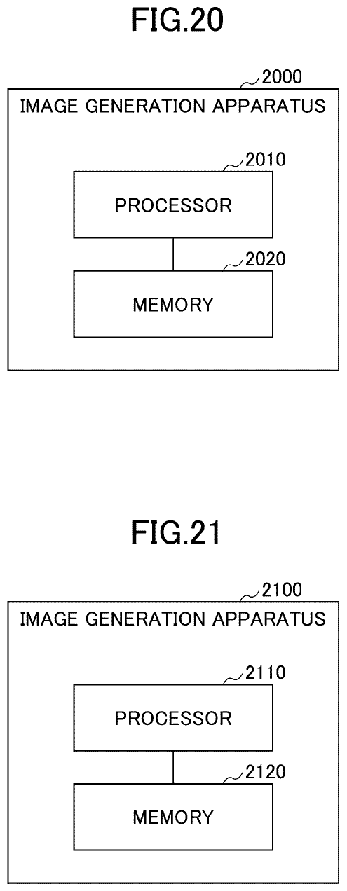

In what follows, an apparatus 2000 for generating an image in accordance with an embodiment of the present disclosure is illustrated by referring to FIG. 20 that is a block diagram of the apparatus 2000. As shown in FIG. 20, the apparatus 2000 may be a computer or server, for example.

The apparatus 2000 represented in FIG. 20 may be inclusive of a processor(s) 2010 and memory 2020. Of course, in addition to these, the apparatus 2000 may also include an input unit, output unit (not shown), etc., and these components may be interconnected via a bus system and/or other forms of connection mechanisms. Here, it should be noted that the components and structure of the apparatus 2000 shown in FIG. 20 are merely exemplary ones, and the apparatus 2000 may also have other components and structures as needed.

The processor(s) 2010 may be a central processing unit (CPU) or other processing unit with data processing and/or instruction execution capabilities; that is, the processor(s) 2010 may adopt any one of the conventional processors in the related art. The memory 2020 may include various forms of computer-readable storage media, such as a volatile memory, non-volatile memory, and the like; in other words, the memory 2020 may adopt any one of the existing storages in the related art. Computer program instructions (i.e., a computer program) for executing the image generation method described above with reference to FIG. 1 as well as various application programs and data may be stored in the memory 2020. The processor(s) 2010 may be configured to execute the computer program stored in the memory 2020 to achieve the image generation method described above by referring to FIG. 1. Concretely, the processor(s) 2010 may be configured to execute the computer program stored in the memory 2020 to fulfill STEPS S101 to S103 of FIG. 1, respectively. Here, it should be mentioned that for the reason that STEPS S101 to S103 in FIG. 1 have been minutely described in the above embodiment, the details of them are omitted in the embodiment of the present disclosure. In addition, the apparatus 2000 may also achieve the same technical effect as the image generation method described above with reference to FIG. 1.

Hereinafter, by referring to FIG. 21, an apparatus 2100 for image generation in accordance with an embodiment of the present disclosure is described. FIG. 21 shows a block diagram of the apparatus 2100. As illustrated in FIG. 21, the apparatus 2100 may be a computer or server, for example.

The apparatus 2100 represented in FIG. 21 may contain a processor(s) 2110 and memory 2120. Of course, in addition to these, the apparatus 2100 may also include an input unit, output unit (not shown), etc., and these components may be interconnected via a bus system and/or other forms of connection mechanisms. Here, it should be pointed out that the components and structure of the apparatus 2100 shown in FIG. 21 are just exemplary ones, and the apparatus 2100 may also have other components and structures as needed.

The processor(s) 2110 may be a central processing unit (CPU) or other processing unit with data processing and/or instruction execution capabilities; that is, the processor(s) 2110 may utilize any one of the conventional processors in the related art. The memory 2120 may include various forms of computer-readable storage media, such as a volatile memory, non-volatile memory, and the like; in other words, the memory 2120 may employ any one of the existing storages in the related art. Computer program instructions (i.e., a computer program) for executing the image generation method described above with reference to FIG. 2 as well as various application programs and data may be stored in the memory 2120. The processor(s) 2110 may be configured to execute the computer program stored in the memory 2120 to fulfill the image generation method described above with reference to FIG. 2. Specifically, the processor(s) 2110 may be configured to execute the computer program stored in the memory 2120 to achieve STEPS S201 to S203 of FIG. 2, respectively. Here, it should be noted that for the reason that STEPS S201 to S203 in FIG. 2 have been minutely described in the above embodiment, the details of them are omitted in the embodiment of the present disclosure. In addition, the apparatus 2100 may also achieve the same technical effect as the image generation method described above by referring to FIG. 2.

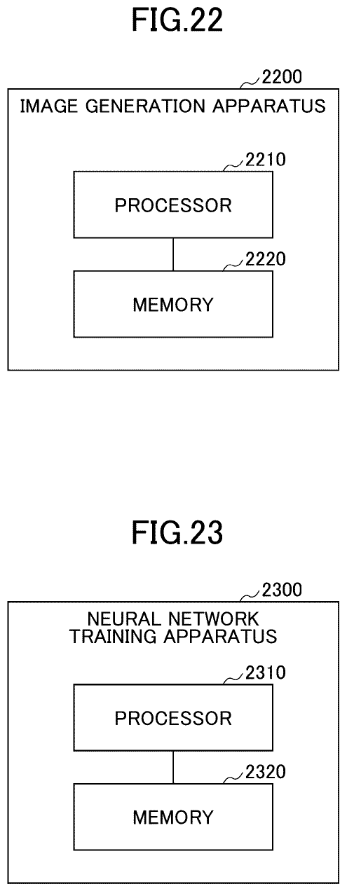

In what follows, with reference to FIG. 22, an apparatus 2200 for generating an image in accordance with an embodiment of the present disclosure is illustrated. FIG. 22 is a block diagram of the apparatus 2200. As shown in FIG. 22, the apparatus 2200 may be a computer or server, for example.

The apparatus 2200 represented in FIG. 22 may include a processor(s) 2210 and memory 2220. Of course, in addition to these, the apparatus 2200 may also include an input unit, output unit (not shown), etc., and these components may be interconnected via a bus system and/or other forms of connection mechanisms. Here, it should be mentioned that the components and structure of the apparatus 2200 shown in FIG. 22 are just exemplary ones, and the apparatus 2200 may also have other components and structures as needed.

The processor(s) 2210 may be a central processing unit (CPU) or other processing unit with data processing and/or instruction execution capabilities; that is, the processor(s) 2210 may utilize any one of the conventional processors in the related art. The memory 2220 may include various forms of computer-readable storage media, such as a volatile memory, non-volatile memory, and the like; in other words, the memory 2220 may adopt any one of the existing storages in the related art. Computer program instructions (i.e., a computer program) for executing the image generation method described above with reference to FIG. 3 as well as various application programs and data may be stored in the memory 2220. The processor(s) 2210 may be configured to execute the computer program stored in the memory 2220 to achieve the image generation method described above with reference to FIG. 3. Concretely, the processor(s) 2210 may be configured to execute the computer program stored in the memory 2220 to accomplish STEPS S301 to S304 of FIG. 3, respectively. Here, it should be noted that for the reason that STEPS S301 to S304 in FIG. 3 have been minutely described in the above embodiment, the details of them are omitted in the embodiment of the present disclosure. In addition, the apparatus 2200 may also achieve the same technical effect as the image generation method described above with reference to FIG. 3.

Hereinafter, by referring to FIG. 23, an apparatus 2300 for neural network training in accordance with an embodiment of the present disclosure is illustrated. FIG. 23 represents a block diagram of the apparatus 2300. As shown in FIG. 23, the apparatus 2300 may be a computer or server, for example.

The apparatus 2300 represented in FIG. 23 may be inclusive of a processor(s) 2310 and memory 2320. Of course, in addition to these, the apparatus 2300 may also include an input unit, output unit (not shown), etc., and these components may be interconnected via a bus system and/or other forms of connection mechanisms. Here, it should be pointed out that the components and structure of the apparatus 2300 shown in FIG. 23 are just exemplary ones, and the apparatus 2300 may also have other components and structures as needed.

The processor(s) 2310 may be a central processing unit (CPU) or other processing unit with data processing and/or instruction execution capabilities; that is, the processor(s) 2310 may adopt any one of the conventional processors in the related art. The memory 2320 may include various forms of computer-readable storage media, such as a volatile memory, non-volatile memory, and the like; in other words, the memory 2320 may utilize any one of the existing storages in the related art. Computer program instructions (i.e., a computer program) for executing the neural network training method described above with reference to FIG. 4 as well as various application programs and data may be stored in the memory 2320. The processor(s) 2310 may be configured to execute the computer program stored in the memory 2320 to achieve the neural network training method described above by referring to FIG. 4. Specifically, the processor(s) 2310 may be configured to execute the computer program stored in the memory 2320 to achieve STEPS S401 and S402 of FIG. 4, respectively. Here, it should be pointed out that for the reason that STEPS S401 and S402 in FIG. 4 have been minutely described in the above embodiment, the details of them are omitted in the embodiment of the present disclosure. In addition, the apparatus 2300 may also attain the same technical effect as the neural network training method described above with reference to FIG. 4.

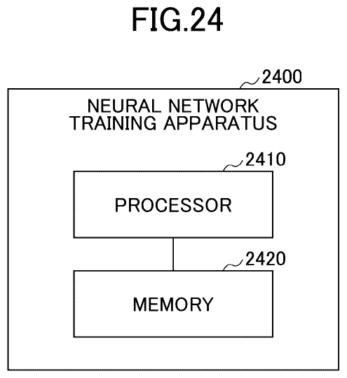

In what follows, by referring to FIG. 24, an apparatus 2400 for training a neural network in accordance with an embodiment of the present disclosure is described. FIG. 24 is a block diagram of the apparatus 2400. As represented in FIG. 24, the apparatus 2400 may be a computer or server, for example.

The apparatus 2400 shown in FIG. 24 may be inclusive of a processor(s) 2410 and memory 2420. Of course, in addition to these, the apparatus 2400 may also include an input unit, output unit (not shown), etc., and these components may be interconnected via a bus system and/or other forms of connection mechanisms. Here, it should be mentioned that the components and structure of the apparatus 2400 shown in FIG. 24 are merely exemplary ones, and the apparatus 2400 may also have other components and structures as needed.

The processor(s) 2410 may be a central processing unit (CPU) or other processing unit with data processing and/or instruction execution capabilities; that is, the processor(s) 2410 may adopt any one of the conventional processors in the related art. The memory 2420 may include various forms of computer-readable storage media, such as a volatile memory, non-volatile memory, and the like; in other words, the memory 2420 may make use of any one of the existing storages in the related art. Computer program instructions (i.e., a computer program) for executing the neural network training method described above with reference to FIG. 5 as well as various application programs and data may be stored in the memory 2420. The processor(s) 2410 may be configured to execute the computer program stored in the memory 2420 to accomplish the neural network training method described above with reference to FIG. 5. Minutely, the processor(s) 2410 may be configured to execute the computer program stored in the memory 2420 to fulfill STEPS S501 and S502 of FIG. 5, respectively. Here, it should be noted that for the reason that STEPS S501 and S502 in FIG. 5 have been concretely described in the above embodiment, the details of them are omitted in the embodiment of the present disclosure. In addition, the apparatus 2400 may also achieve the same technical effect as the neural network training method described above with reference to FIG. 5.

Moreover, a computer-executable program (i.e., a computer program) and non-transitory computer-readable medium are provided according to an embodiment of the present disclosure. The computer program may cause a computer to perform any one of the image generation methods and neural network training methods in accordance with the above embodiments. The non-transitory computer-readable medium may store a computer-executable program (i.e., a computer program) for execution by a computer involving a processor(s). The computer program may, when executed by the processor(s), cause the processor(s) to execute any one of the image generation methods and neural network training methods in accordance with the above embodiments.

Here, it should be pointed out that the above embodiments are just exemplary ones, and the specific structure and operation of them are not used for limiting the present disclosure.

In addition, the embodiments of the present disclosure may be implemented in any convenient form, for example, using dedicated hardware or a mixture of dedicated hardware and software. The embodiments of the present disclosure may be implemented as computer software executed by one or more networked processing apparatuses. The network may include any conventional terrestrial or wireless communications network, such as the Internet, and the like. The processing apparatuses may include any suitably programmed apparatuses such as a general-purpose computer, a personal digital assistant, a mobile telephone (such as a WAP or 3G, 4G, or 5G-compliant phone), and so on. Because the embodiments of the present disclosure may be implemented as software, each and every aspect of the present disclosure thus encompasses computer software implementable on a programmable device.

The computer software may be provided to the programmable device using any storage medium for storing processor-readable code such as a floppy disk, a hard disk, a CD ROM, a magnetic tape device, a solid state memory device, and so forth.

The related hardware platform may include any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of storing a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

While the present disclosure is described with reference to the specific embodiments chosen for purpose of illustration, it should be apparent that the present disclosure is not limited to these embodiments, but numerous modifications may be made thereto by a person skilled in the art without departing from the basic concept and technical scope of the present disclosure.

What is claimed is

1. A method of generating an image, comprising:
obtaining a first target image for image generation;
obtaining a reference depth image indicating a reference depth feature of the first target image as well as a reference edge image indicating a reference edge feature of the first target image; and
generating, based on the reference depth image and the reference edge image, a first depth image and a first edge image corresponding to the first target image by utilizing a first generative neural network.

2. The method according to claim 1, wherein,
the generation of the first depth image and the first edge image includes
performing processes on one or more of the first target image, the reference depth image, and the reference edge image, respectively, and generating the first depth image and the first edge image on the basis of the processed images.

3. The method according to claim 2, wherein,
the processes respectively performed on the first target image, the reference depth image, and the reference edge image are different.

4. The method according to claim 2, wherein,
the processes include enhancement processing and/or editing processing, wherein, the enhancement processing includes one or more operations of image distortion, image flipping, image rotation, image cropping, edge adjustment, image translation, and image scaling with respect to a global or local region of an image, and the editing processing includes dividing an image into regions on the basis of the image's semantics and/or shape and performing one or more operations of adding, deleting, and modifying on each of the divided regions.

5. The method according to claim 1, further comprising:
generating, based on the first target image, a third depth color image and a third edge color image respectively corresponding to the first depth image and the first edge image by utilizing a second generative neural network.

6. The method according to claim 5, wherein,
the generation of the third depth color image and the third edge color image includes
performing processes on one or more of the first target image, the first depth image, and the first edge image, respectively, and generating the third depth color image and the third edge color image on the basis of the processed images.

7. The method according to claim 6, wherein,
the processes respectively performed on the first target image, the first depth image, and the first edge image are different.

8. The method according to claim 6, wherein,
the processes include enhancement processing and/or editing processing, wherein, the enhancement processing includes one or more operations of image distortion, image flipping, image rotation, image cropping, edge adjustment, image translation, and image scaling with respect to a global or local region of an image, and the editing processing includes dividing an image into regions on the basis of the image's semantics and/or shape and performing one or more operations of adding, deleting, and modifying on each of the divided regions.

9. An apparatus for generating an image, comprising:
a processor; and
a memory coupled to the processor, storing a computer program,
wherein, the computer program causes, when executed by the processor, the processor to implement
obtaining a first target image for image generation;
obtaining a reference depth image indicating a reference depth feature of the first target image as well as a reference edge image indicating a reference edge feature of the first target image; and
generating, based on the reference depth image and the reference edge image, a first depth image and a first edge image corresponding to the first target image by utilizing a first generative neural network.

10. The apparatus according to claim 9, wherein,
the generation of the first depth image and the first edge image includes
performing processes on one or more of the first target image, the reference depth image, and the reference edge image, respectively, and generating the first depth image and the first edge image on the basis of the processed images.

11. The apparatus according to claim 10, wherein,
the processes respectively performed on the first target image, the reference depth image, and the reference edge image are different.

12. The apparatus according to claim 10 wherein,
the processes include enhancement processing and/or editing processing, wherein, the enhancement processing includes one or more operations of image distortion, image flipping, image rotation, image cropping, edge adjustment, image translation, and image scaling with respect to a global or local region of an image, and the editing processing includes dividing an image into regions on the basis of the image's semantics and/or shape and performing one or more operations of adding, deleting, and modifying on each of the divided regions.

13. The apparatus according to claim 9, wherein,
the computer program further causes, when executed by the processor, the processor to implement
generating, based on the first target image, a third depth color image and a third edge color image respectively corresponding to the first depth image and the first edge image by utilizing a second generative neural network.

14. The apparatus according to claim 13, wherein,
the generation of the third depth color image and the third edge color image includes
performing processes on one or more of the first target image, the first depth image, and the first edge image, respectively, and generating the third depth color image and the third edge color image on the basis of the processed images.

15. The apparatus according to claim 14, wherein,
the processes respectively performed on the first target image, the first depth image, and the first edge image are different.

16. The apparatus according to claim 14, wherein,
the processes include enhancement processing and/or editing processing, wherein, the enhancement processing includes one or more operations of image distortion, image flipping, image rotation, image cropping, edge adjustment, image translation, and image scaling with respect to a global or local region of an image, and the editing processing includes dividing an image into regions on the basis of the image's semantics and/or shape and performing one or more operations of adding, deleting, and modifying on each of the divided regions.

17. A method of training a neural network, comprising:
inputting a first training target image as well as a first training depth image indicating a reference depth feature of the first training target image and a first training edge image indicating a reference edge feature of the first training target image; and
generating, based on the first training depth image and the first training edge image, a first training depth generation image and a first training edge generation image corresponding to the first training target image by utilizing a first generative neural network, so as to train the first generative neural network and adjust a parameter(s) of the first generative neural network.

18. The method according to claim 17, wherein,
the generation of the first training depth generation image and the first training edge generation image includes
performing processes on one or more of the first training target image, the first training depth image, and the firs training edge image, respectively, and generating the first training depth generation image and the first training edge generation image on the basis of the processed images.

19. The method according to claim 18, wherein,
the processes respectively performed on the first training target image, the first training depth image, and the first training edge image are different.

20. The method according to claim 18, wherein,
the processes include enhancement processing and/or editing processing, wherein, the enhancement processing includes one or more operations of image distortion, image flipping, image rotation, image cropping, edge adjustment, image translation, and image scaling with respect to a global or local region of an image, and the editing processing includes dividing an image into regions on the basis of the image's semantics and/or shape and performing one or more operations of adding, deleting, and modifying on each of the divided regions.
